(19) United States
(12) Patent Application Publication
(10) Pub. No.: US 2021/0072909 A1
(43) Pub. Date: Mar. 11, 2021

(54) INFORMATION PROCESSING APPARATUS, CONTROL METHOD, AND STORAGE MEDIUM

(71) Applicant: NEC Corporation, Tokyo (JP)

(72) Inventors: Satoshi YOSHIDA, Tokyo (JP); Kenichiro ISHIKAWA, Tokyo (JP); Shoji NISHIMURA, Tokyo (JP)

(73) Assignee: NEC Corporation, Tokyo (JP)

(21) Appl. No.: 16/957,474

(22) PCT Filed: Nov. 24, 2018
(86) PCT No.: PCT/JP2018/043166

§ 371 Date: Jun. 24, 2020

(30) Foreign Application Priority Data
Dec. 25, 2017 (JP) 2017-247545

(51) Int. Cl. G06F 3/06

(52) U.S. Cl. CPC G06F 3/0631; G06F 3/067; G06F 3/0638; G06F 3/0689; G06F 3/0605

(57) ABSTRACT

An information processing apparatus according to this invention, upon acquiring target data, computes an evaluation value between the target data and each piece of representative data. The information processing apparatus determines, for each piece of representative data, whether the evaluation value computed between the representative data and the target data satisfies a predetermined relationship with a threshold related to the representative data. When it is determined that the evaluation value computed between the target data and certain representative data satisfies the predetermined relationship with the threshold related to the representative data, the information processing apparatus stores the target data in a storage area related to the representative data. The information processing apparatus updates the threshold related to each piece of representative data. The update of the threshold related to certain representative data is performed based on the total size or the total count of pieces of data stored in a storage area related to the representative data, or the free space of the storage area related to the representative data.

### TECHNICAL FIELD

The present invention relates to distributed storage of data.

### BACKGROUND ART

A system for distributing data to a plurality of computational resources has been developed. PTL 1, for example, discloses a technique for, in distributing data to a plurality of computational resources, preventing a degree of similarity between pieces of data to be deployed on the same computational resource from increasing while nearly uniformly allocating a piece of data to each computational resource.

### CITATION LIST

### Patent Literature

[PTL 1] Japanese Unexamined Patent Application Publication No. 2016-45850

### SUMMARY OF INVENTION

### Technical Problem

The inventors of the present invention discovered a new technique for distributing and storing pieces of data in a plurality of storage areas. One object of the present invention is to provide a new technique for distributing and storing pieces of data in a plurality of storage areas.

### Solution to Problem

An information processing apparatus according to the present invention includes 1) an evaluation unit that acquires target data, and computes, for the acquired target data, an evaluation value with reference to each of a plurality of pieces of representative data, 2) an allocation unit that acquires management information indicating a threshold and a storage area in association with pieces of representative data, determines, for each piece of representative data, whether the evaluation value of the target data with reference to the representative data satisfies a predetermined relationship with the threshold related to the representative data, and stores the target data in the storage area related to the representative data when the evaluation value of the target data with reference to the representative data satisfies the predetermined relationship with the threshold related to the representative data, and 3) an update unit that updates the threshold related to the representative data, based on a total size or a total count of pieces of data stored in the storage area related to the representative data, or a free space of the storage area related to the representative data.

A control method according to the present invention is a control method executed by a computer. The control method includes 1) an evaluation step of acquiring target data, and computing, for the acquired target data, an evaluation value with reference to each of a plurality of pieces of representative data, 2) an allocation step of acquiring management information indicating a threshold and a storage area in association with pieces of representative data, determining, for each piece of representative data, whether the evaluation value of the target data with reference to the representative data satisfies a predetermined relationship with the threshold related to the representative data, and storing the target data in the storage area related to the representative data when the evaluation value of the target data with reference to the representative data satisfies the predetermined relationship with the threshold related to the representative data, and 3) an update step of updating the threshold related to the representative data, based on a total size or a total count of pieces of data stored in the storage area related to the representative data, or a free space of the storage area related to the representative data.

A program according to the present invention causes a computer to execute each of the steps of the control method according to the present invention.

### Advantageous Effects of Invention

The present invention provides a new technique for distributing and storing pieces of data in a plurality of storage areas.

### BRIEF DESCRIPTION OF DRAWINGS

The above and other objects, features, and advantages will be more apparent from the following description of preferred example embodiments taken in conjunction with the following accompanying drawings.

FIG. 1 is a diagram for explaining an overview of an information processing apparatus according to a first example embodiment.

FIG. 2 is a diagram illustrating the functional configuration of the information processing apparatus according to the first example embodiment.

FIG. 3 is a diagram illustrating a computer for implementing the information processing apparatus.

FIG. 4 is a diagram illustrating the environment under which the information processing apparatus is used.

FIG. 5 is a flowchart illustrating the sequence of processing performed by the information processing apparatus according to the first example embodiment.

FIG. 6 is a diagram illustrating a similarity tree according to Example 1.

FIG. 7 is a diagram illustrating a distributed system according to Example 1.

### DESCRIPTION OF EMBODIMENTS

An example embodiment of the present invention will be described below with reference to the drawings. It should be noted that, in all the drawings, the same reference numerals denote the same components, and a description thereof will not be repeated as appropriate. Unless otherwise specified, in each block diagram, the blocks do not represent hardware-specific configurations, but represent function-specific configurations.

### First Example Embodiment

### Overview

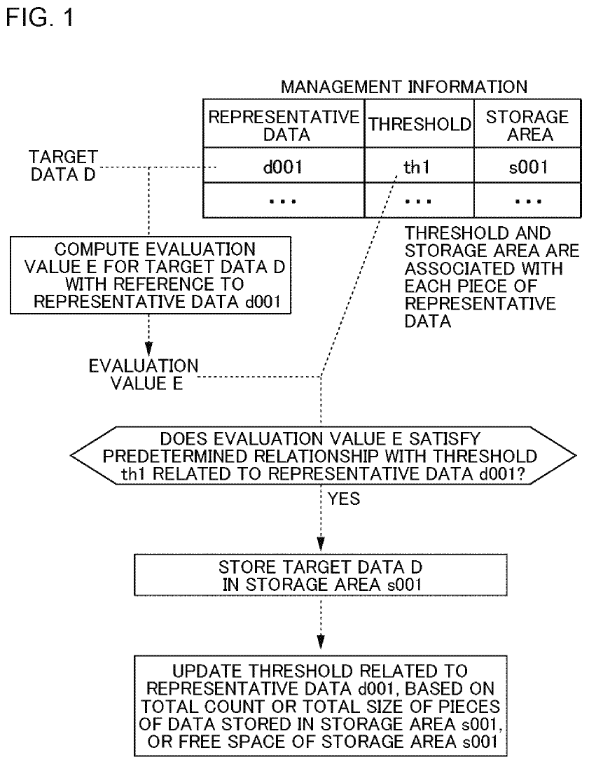

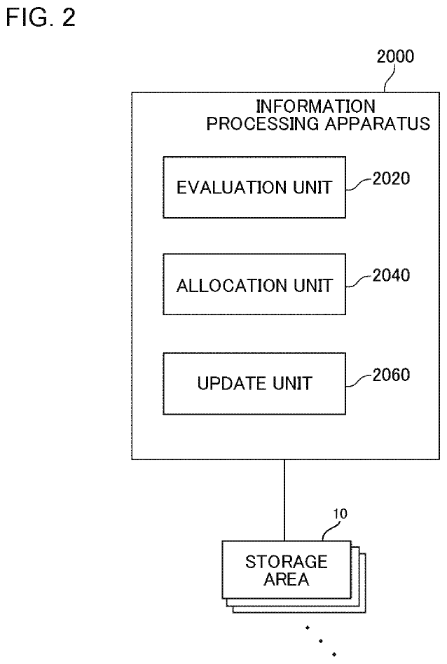

FIG. 1 is a diagram for explaining an overview of an information processing apparatus (an information processing apparatus 2000 illustrated in FIG. 2) according to a first example embodiment. The operation of the information processing apparatus 2000 to be described hereinafter is merely an example for facilitating an understanding of the information processing apparatus 2000, and the operation of the information processing apparatus 2000 is not limited to the following example. The details and variations of the operation of the information processing apparatus 2000 will be described later.

The information processing apparatus 2000 determines one of a plurality of storage areas used to store data (to be referred to as target data hereinafter) to be stored in the storage area. Each storage area is associated with representative data. A threshold used for determination processing (to be described later) is also associated with the representative data. Information in which storage areas and thresholds are associated with pieces of representative data will be referred to as management information hereinafter.

The information processing apparatus 2000, upon acquiring target data, computes an evaluation value between the target data and each piece of representative data (for example, the degree of similarity between the target data and the representative data). The information processing apparatus 2000 determines, for each piece of representative data, whether the evaluation value computed between the representative data and the target data satisfies a predetermined relationship with a threshold related to the representative data. When the degree of similarity between the target data and representative data is computed as the evaluation value, an example of the predetermined relationship is the relationship “the degree of similarity between the target data and representative data is equal to or more than a threshold related to the representative data.”

When it is determined that the evaluation value computed between the target data and certain representative data satisfies the predetermined relationship with a threshold related to the representative data, the information processing apparatus 2000 stores the target data in a storage area related to the representative data. It should be noted that, the case where a plurality of pieces of representative data for which the evaluation values and the thresholds are determined to satisfy the predetermined relationship exist will be described later.

The information processing apparatus 2000 further includes the function of updating the threshold related to each piece of representative data. The update of the threshold related to certain representative data is performed based on the total size or the total count of data stored in a storage area related to the representative data, or the free space of the storage area related to the representative data.

### Advantageous Effect

With the information processing apparatus 2000 according to this example embodiment, when the evaluation value of the target data with reference to representative data satisfies a predetermined relationship with a threshold related to the representative data, the target data is stored in a storage area related to the representative data. The threshold related to the representative data is updated based on the total size or the total count of data stored in the storage area related to the representative data, or the free space of the storage area related to the representative data.

Conceptually, the information processing apparatus 2000 updates a threshold related to representative data to set a lower probability that the evaluation value of the target data with reference to the representative data and the threshold related to the representative data satisfy the above-mentioned predetermined relationship between them, for a larger volume of data stored in a storage area 10 related to the representative data. This makes it possible that the larger a volume of data stored in the storage area 10 related to the representative data, the lower a probability that the target data is stored in the storage area 10 related to the representative data. In this manner, the information processing apparatus 2000 balances the volume of data stored in each storage area 10 between pluralities of storage areas 10 by adjusting the probability that the target data is stored in the storage area 10 by updating the threshold. Thus, the volume of data stored in each storage area can be balanced by a simple method of updating the threshold.

As another advantage of this method, a new storage area 10 can easily be added. That the larger the volume of data stored in a storage area 10 related to representative data, the lower the probability that the target data is stored in the storage area 10 means that the probability that the target data is stored in a storage area 10 which is newly added and therefore stores a small volume of data is higher. Consequently, the information processing apparatus 2000 balances the volumes of data between the storage areas 10, including the newly added storage area 10. Therefore, this obviates the need for an operation of balancing the volumes of data between the storage areas 10 by moving data from an existing storage area 10 to the newly added storage area 10. In other words, it is easy to add a new storage area 10.

The information processing apparatus 2000 according to this example embodiment will be described in more detail below.

### Exemplary Functional Configuration of Information Processing Apparatus 2000

FIG. 2 is a diagram illustrating the functional configuration of the information processing apparatus 2000 according to the first example embodiment. The information processing apparatus 2000 includes an evaluation unit 2020, an allocation unit 2040, and an update unit 2060. The evaluation unit 2020 acquires target data. The evaluation unit 2020 computes an evaluation value with reference to each of a plurality of pieces of representative data, for the acquired target data. The allocation unit 2040 acquires management information. The allocation unit 2040 determines, using the management information, whether the evaluation value of the target data computed with reference to each piece of representative data satisfies a predetermined relationship with a threshold related to this piece of representative data. When the evaluation value satisfies the predetermined relationship with the threshold related to the certain representative data, the allocation unit 2040 stores the target data in a storage area 10 related to the representative data. The update unit 2060 updates the threshold related to the representative data, based on the total size or the total count of data stored in the storage area 10 related to the representative data, or the free space of the storage area 10 related to the representative data.

### Hardware Configuration of Information Processing Apparatus 2000

Each functional configuration unit of the information processing apparatus 2000 may be implemented as hardware (for example, a hard-wired electronic circuit) for implementing this functional configuration unit, or may be implemented as a combination of hardware and software (for example, a combination of an electronic circuit and a program for controlling it). The case where each functional configuration unit of the information processing apparatus 2000 is implemented as a combination of hardware and software will further be described below.

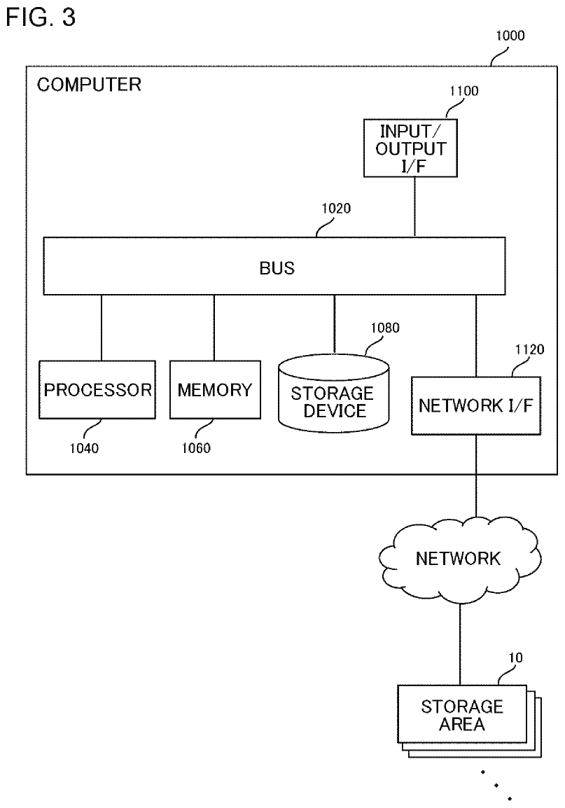

FIG. 3 is a diagram illustrating a computer 1000 for implementing the information processing apparatus 2000. The computer 1000 is implemented as an arbitrary computer. Examples of the computer 1000 include a personal computer (PC) and a server machine. The computer 1000 may be implemented as a general-purpose computer or a dedicated computer designed to implement the information processing apparatus 2000.

The computer 1000 includes a bus 1020, a processor 1040, a memory 1060, a storage device 1080, an input/output interface 1100, and a network interface 1120. The bus 1020 serves as a data transmission line for allowing the processor 1040, the memory 1060, the storage device 1080, the input/output interface 1100, and the network interface 1120 to transmit and receive data to and from each other. The method for connecting the processor 1040 and the like to each other, however, is not limited to bus connection. The processor 1040 includes various processors such as a central processing unit (CPU), a graphics processing unit (GPU), or a field-programmable gate array (FPGA). The memory 1060 serves as a main storage implemented using, for example, a random access memory (RAM). The storage device 1080 serves as an auxiliary storage implemented using, for example, a hard disk, a solid state drive (SSD), a memory card, or a read only memory (ROM).

The input/output interface 1100 is used to connect the computer 1000 to an input/output device. An input device such as a keyboard and an output device such as a display device, for example, are connected to the input/output interface 1100.

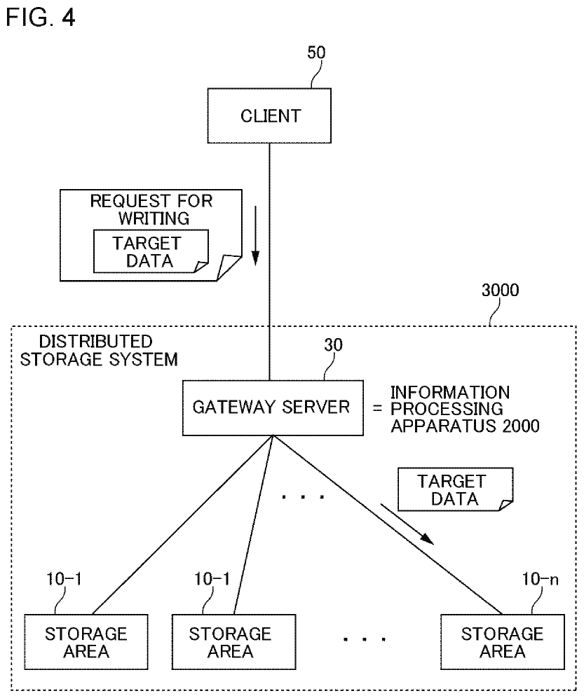

The network interface 1120 is used to connect the computer 1000 to a network. Examples of the communication network include a local area network (LAN) and a wide area network (WAN). The method for connection to the network by the network interface 1120 may be either wireless or wired connection. Referring to FIG. 4, the storage areas 10 are connected to the computer 1000 via the network.

The storage device 1080 stores a program module for implementing each functional configuration unit of the information processing apparatus 2000. The processor 1040 implements a function related to each program module by reading these program modules into the memory 1060 and executing them.

### Details of Storage Area 10

The storage area 10 is any storage area that can store data. An example of the storage area 10 is one physical storage. Another example of the storage area 10 is one virtual storage. The virtual storage may be implemented herein as a part of one physical storage, or a combination of a plurality of physical storages. It should be noted that, an existing technique is available as a technique for handling a part of one physical storage virtually as one storage, or a technique for handling a combination of a plurality of physical storages virtually as one storage.

### Usage Example of Information Processing Apparatus 2000

To facilitate an understanding of the information processing apparatus 2000, the environment under which the information processing apparatus 2000 is used will be exemplified below. FIG. 4 is a diagram illustrating the environment under which the information processing apparatus 2000 is used. Referring to FIG. 4, the information processing apparatus 2000 and the plurality of storage areas 10 configure a distributed storage system 3000. The information processing apparatus 2000 serves as a gateway server for the distributed storage system 3000. More specifically, the information processing apparatus 2000 receives, from a client 50 that uses the distributed storage system 3000, a request (to be referred to as a request for writing hereinafter) to write data into any storage area 10, or a request (to be referred to as a request for reading hereinafter) to read data from any storage area 10.

Referring to FIG. 4, a request for writing is transmitted from the client 50. The request for writing contains the above-mentioned target data. The information processing apparatus 2000 determines a storage area 10 used to store the target data contained in the request for writing and stores this target data in the storage area 10, by performing each of the above-mentioned processes for the target data. Referring again to FIG. 4, the information processing apparatus 2000 determines a storage area 10-n as the storage area 10 used to store the target data. Therefore, the target data is transmitted to the storage area 10-n.

### Sequence of Processing

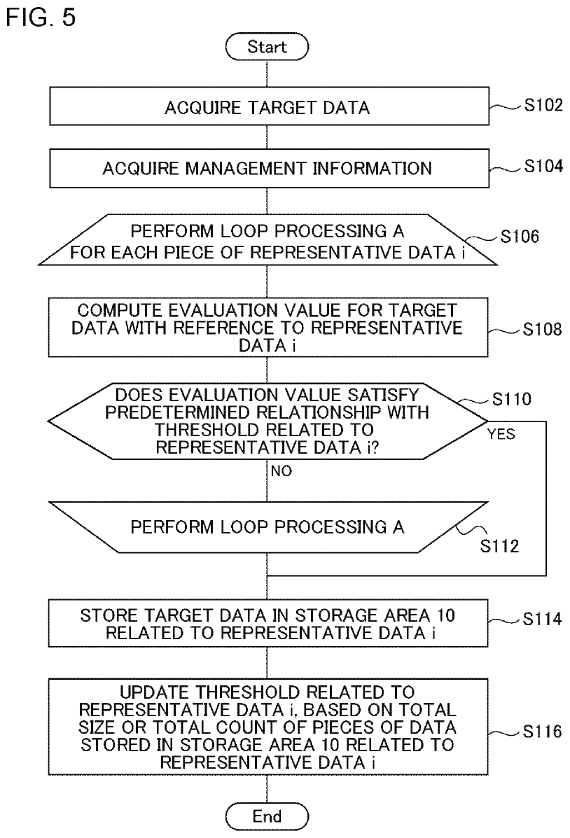

FIG. 5 is a flowchart illustrating the sequence of processing performed by the information processing apparatus 2000 according to the first example embodiment. The evaluation unit 2020 acquires target data (S102). The allocation unit 2040 acquires management information (S104). Steps S106 to S112 constitute loop processing performed for each of a plurality of pieces of representative data. The information processing apparatus 2000 determines in step S106 whether loop processing A has already been performed for all pieces of representative data. When the loop processing A has already been performed for all the pieces of representative data, the process of FIG. 5 ends. On the other hand, when pieces of representative data still remain to undergo the loop processing A, the information processing apparatus 2000 performs the loop processing A for one of the pieces of representative data. The representative data to undergo the loop processing A will be referred to as representative data i hereinafter.

The evaluation unit 2020 computes an evaluation value for the target data with reference to the representative data i (S108). The allocation unit 2040 determines whether the evaluation value computed with reference to the representative data i satisfies a predetermined relationship with a threshold related to the representative data i (S110). When the evaluation value computed with reference to the representative data i does not satisfy the predetermined relationship with the threshold related to the representative data i (NO in step S110), the process of FIG. 5 advances to step S106 (S112).

When the evaluation value computed with reference to the representative data i satisfies the predetermined relationship with the threshold related to the representative data i (YES in step S110), the allocation unit 2040 stores the target data in a storage area 10 related to the representative data i (S114). The update unit 2060 updates the threshold related to the representative data i, based on the total size or the total count of data stored in the storage area 10 related to the representative data i, or the free space of the storage area 10 related to the representative data i (S116).

It should be noted that, FIG. 5 illustrates an exemplary sequence of processing performed by the information processing apparatus 2000, and the sequence of processing performed by the information processing apparatus 2000 is not limited to the example illustrated in FIG. 5. Referring to FIG. 5, for example, when the evaluation value computed with reference to one certain piece of representative data satisfies the predetermined relationship with a threshold, the target data is stored in a storage area 10 related to the representative data. The information processing apparatus 2000, however, may, after determining whether the evaluation value computed with reference to each of all pieces of representative data satisfies the predetermined relationship with a threshold, select one from among the pieces of representative data for which the evaluation values are determined to satisfy the predetermined relationship with the thresholds, and store the target data in a storage area 10 related to the selected piece of representative data.

### Acquisition of Target Data: S102

The evaluation unit 2020 acquires target data (S102). A variety of methods are available herein for the information processing apparatus 2000 acquiring target data to be stored in any storage area 10. The information processing apparatus 2000, for example, acquires target data transmitted from another computer. An example of the target data transmitted from another computer is the target data contained in the above-mentioned request for writing. As another example, the information processing apparatus 2000 acquires, as the target data, data input using an input device connected to the information processing apparatus 2000.

### Acquisition of Management Information: S104

The allocation unit 2040 acquires management information (S104). The management information is stored in advance in a storage (for example, the storage device 1080) accessible from the allocation unit 2040. The allocation unit 2040 acquires the management information by accessing the storage.

### Computation of Evaluation Value: S108

The evaluation unit 2020 computes an evaluation value for the target data with reference to representative data (S108). A variety of methods are available to compute an evaluation value. The evaluation unit 2020, for example, computes a degree of similarity between the representative data and the target data, and sets the computed degree of similarity as the evaluation value of the target data with reference to the representative data. Various existing approaches are available herein to compute a degree of similarity between the pieces of data. It is assumed, for example, that both the representative data and the target data are embodied as image data. In this case, the evaluation unit 2020, for example, computes, as the degree of similarity between the representative data and the target data, a degree of similarity between a feature value extracted from the representative data and a feature value extracted from the target data. It should be noted that, the feature value extracted from the representative data is preferably included in the management information in advance.

As another example, the evaluation unit 2020 may compute a distance between the representative data and the target data, and set the distance as the evaluation value of the target data with reference to the representative data. It is assumed, for example, that both the representative data and the target data are embodied as multidimensional data. In this case, the evaluation unit 2020 computes a distance between the representative data and the target data on a multidimensional space, and sets the distance as the evaluation value. It should be noted that, an existing technique is available to compute a distance between the pieces of data.

### Storage of Target Data: S114

The allocation unit 2040 stores the target data in a storage area 10 related to representative data for which the evaluation value is determined to satisfy the predetermined relationship with the threshold (S114). It should be noted that, an existing technique is available to store data in a desired storage area.

The above-mentioned predetermined relationship depends herein on how to define the evaluation value. It is assumed, for example, that the degree of similarity between representative data and the target data is set as the evaluation value of the target data with reference to the representative data. In this case, the relationship “the evaluation value of the target data with reference to representative data is equal to or more than a threshold related to the representative data,” for example, is used as the predetermined relationship. In other words, the allocation unit 2040 determines in step S114 of FIG. 4 whether the degree of similarity between the representative data i and the target data is equal to or more than a threshold related to the target data i. When the degree of similarity between the representative data i and the target data is equal to or more than a threshold related to the target data i, it is determined for the representative data i that the evaluation value satisfies the predetermined relationship with the threshold.

It is assumed, as another example, that the distance between representative data and the target data is set as the evaluation value of the target data with reference to the representative data. In this case, the relationship “the evaluation value of the target data with reference to representative data is equal to or less than a threshold related to the representative data,” for example, is used as the predetermined relationship. In other words, the allocation unit 2040 determines in step S114 of FIG. 4 whether the distance between the representative data i and the target data is equal to or less than a threshold related to the target data i. When the distance between the representative data i and the target data is equal to or less than the threshold related to the target data i, it is determined for the representative data i that the evaluation value satisfies the predetermined relationship with the threshold.

A plurality of pieces of representative data for which the evaluation values satisfy the predetermined relationship with the thresholds may exist herein. In this case, the allocation unit 2040 stores the target data in a storage area 10 related to one of the pieces of representative data for which the evaluation values satisfy the predetermined relationship with the thresholds. The allocation unit 2040, for example, determines whether the evaluation value satisfies the predetermined relationship with the threshold, sequentially for each piece of representative data (see FIG. 5). When it is determined for certain representative data that the evaluation value satisfies the predetermined relationship with the threshold, the allocation unit 2040 stores the target data in a storage area 10 related to the representative data. Since a plurality of pieces of representative data are sequentially processed, the target data is stored in a storage area 10 related to representative data for which the evaluation value is determined for the first time to satisfy the predetermined relationship with the threshold.

A variety of methods are available herein to determine the processing order of the pieces of representative data. The allocation unit 2040, for example, processes the pieces of representative data in an order indicated by the management information. As another example, the allocation unit 2040 processes the pieces of representative data in ascending order of total count of data stored in a related storage area 10. As still another example, the allocation unit 2040 processes the pieces of representative data in ascending order of total size of data stored in a related storage area 10. As still another example, the allocation unit 2040 processes the pieces of representative data in descending order of free space of a storage area 10 related to representative data.

The method for storing the target data in a storage area 10 related to one of the pieces of representative data for which the evaluation values satisfy the predetermined relationship with the thresholds is not limited to the above-mentioned methods. The allocation unit 2040, for example, determines a storage area 10 used to store the target data, by comparing the evaluation values between pieces of representative data for which the evaluation values satisfy the predetermined relationship with the thresholds. It is assumed, for example, that the evaluation value is defined as the degree of similarity between the target data and the representative data. In this case, the allocation unit 2040, for example, stores the target data in a storage area 10 related to representative data, having a highest degree of similarity to the target data, of pieces of representative data having degrees of similarity to the target data equal to or more than the thresholds. It is also assumed that the evaluation value is defined as the distance between the target data and the representative data. In this case, the allocation unit 2040, for example, stores the target data in a storage area 10 related to representative data, having a smallest distance from the target data, of pieces of representative data having distances from the target data equal to or less than the thresholds.

As another example, the allocation unit 2040 computes a degree of deviation between the evaluation value and the threshold (for example, the quotient of the absolute value of the difference between the evaluation value and the threshold divided by the threshold), for each piece of representative data for which the evaluation value satisfies the predetermined relationship with the threshold, and stores the target data in a storage area 10 related to representative data having a highest degree of deviation. As still another example, the allocation unit 2040 stores the target data in a storage area 10, having a lowest total count of stored data, of storage areas 10 related to respective pieces of representative data for which the evaluation values satisfy the predetermined relationship with the thresholds. As still another example, the allocation unit 2040 stores the target data in a storage area 10, having a smallest total size of stored data, of storage areas 10 related to respective pieces of representative data for which the evaluation values satisfy the predetermined relationship with the thresholds. As still another example, the allocation unit 2040 stores the target data in a storage area 10, having a largest free space, of storage areas 10 related to respective pieces of representative data for which the evaluation values satisfy the predetermined relationship with the thresholds.

### Case Where No Representative Data for Which Evaluation Value is Equal to or More than Threshold Exists

No representative data for which the evaluation value satisfies the predetermined relationship with the threshold may exist. This refers to the case where for all pieces of representative data, the evaluation value of the target data with reference to representative data does not satisfy the predetermined relationship with a threshold related to the representative data.

In this case, the allocation unit 2040, for example, handles the target data as new representative data. In other words, the allocation unit 2040 adds the target data to the management information as new representative data. In doing so, the allocation unit 2040 associates a storage area 10 and a threshold with the target data to be handled as new representative data.

A variety of methods are available to determine a storage area 10 to be associated with the new representative data. The allocation unit 2040, for example, associates a storage area 10, associated with no representative data, with the new representative data. As another example, the allocation unit 2040 associates, with the new representative data, a storage area 10 having a lowest total count of stored data, a storage area 10 having a smallest total size of stored data, or a storage area 10 having a largest free space, of storage areas 10 already related to other pieces of representative data.

A variety of methods are available to determine a threshold to be associated with the new representative data. For example, a default threshold is defined in advance and associated with the new representative data. As another example, the allocation unit 2040 may compute a threshold to be associated with the new representative data, based on the total count or the total size of data stored in a storage area 10 to be associated with the new representative data, or the free space of the storage area 10. In this case, as a specific method for computing a threshold to be associated with representative data, based on the total count or the total size of data stored in a storage area 10 related to the representative data, or the free space of the storage area 10, a method, to be described below, similar to a method for updating the threshold based on the total count, the total size, or the free space is available.

It should be noted that, when no representative data for which the evaluation value satisfies the predetermined relationship with the threshold exists, the representative data need not always be handled as new representative data. The allocation unit 2040, for example, may discard the target data when no representative data for which the evaluation value satisfies the predetermined relationship with the threshold exists. In this case, the target data is neither stored in any storage area 10, nor added to the management information.

When the target data is discarded, a notification to that effect is preferably made. When discarding of the target data in a case, as illustrated in, for example, FIG. 5, in which the information processing apparatus 2000 serves as a gateway server, the information processing apparatus 2000 transmits a notification indicating that the target data has been discarded, as a response to the request for writing.

### Update of Threshold: S116

The allocation unit 2040 updates a threshold related to representative data, based on the total size or the total count of data stored in a storage area 10 related to the representative data, or the free space of the storage area 10 (S116). The total size of data stored in the storage area 10, the total count of data stored in the storage area 10, and the free space of the storage area 10 will be collectively referred to as the update index values of the storage area 10 hereinafter.

As described earlier, conceptually, the allocation unit 2040 updates a threshold related to representative data to set a lower probability that the evaluation value of the target data with reference to the representative data and the threshold related to the representative data satisfy the above-mentioned predetermined relationship between them, for a larger volume of data stored in a storage area 10 related to the representative data. It is assumed, for example, that the evaluation value of the target data with reference to representative data is defined as the degree of similarity between the representative data and the target data. In this case, the update unit 2060 sets a larger threshold related to representative data for a larger volume of data stored in a storage area 10 related to the representative data. This lowers the probability that the predetermined relationship “the evaluation value is equal to or more than the threshold” is satisfied. It is assumed, as another example, that the evaluation value of the target data with reference to representative data is defined as the distance between the representative data and the target data. In this case, the update unit 2060 sets a smaller threshold related to representative data for a larger volume of data stored in a storage area 10 related to the representative data. This lowers the probability that the predetermined relationship “the evaluation value is equal to or less than the threshold” is satisfied.

A variety of specific methods are available to update a threshold related to representative data. For example, a function for computing a threshold related to representative data from the update index value of a storage area 10 related to the representative data is defined in advance. When the evaluation value of the target data with reference to representative data is defined as the degree of similarity between the representative data and the target data, the function is defined as a function monotonically nondecreasing with increasing total size or total count of data stored in a storage area 10 related to the representative data, or a function monotonically nondecreasing with decreasing free space of the storage area 10 related to the representative data. When the evaluation value of the target data with reference to representative data is defined as the distance between the representative data and the target data, the function is defined as a function monotonically nonincreasing with increasing total size or total count of data stored in a storage area 10 related to the representative data, or a function monotonically nonincreasing with decreasing free space of the storage area 10 related to the representative data. By applying the update index value of a storage area 10 related to representative data for which the threshold is to be updated to the function, the allocation unit 2040 computes a new threshold for the representative data, and updates the management information using the computed threshold.

As another example, a table indicating a threshold in association with each of a plurality of ranges of the update index value of a storage area 10 may be defined in advance. The allocation unit 2040 determines one of the plurality of ranges indicated by the table, which includes the update index value of a storage area 10 related to representative data for which the threshold is to be updated. The allocation unit 2040 sets a threshold related to the determined range as a new threshold related to the representative data.

The allocation unit 2040 may update a threshold related to representative data at various timings. The allocation unit 2040, for example, updates a threshold related to certain representative data when target data is stored in a storage area 10 related to the representative data. When, however, the threshold obtained by each of the above-mentioned methods is equal to the current threshold, the update unit 2060 need not always update the threshold.

The update of the threshold need not always be performed every time target data is stored. The update unit 2060, for example, updates a threshold related to representative data every time target data is stored in a storage area 10 related to the representative data a predetermined number of times.

### EXAMPLE

A more specific implementation method for the information processing apparatus 2000 will be described below as an Example. In Example 1, the information processing apparatus 2000 performs distribution management of a similarity tree. The details of the similarity tree have been disclosed in PCT International Publication No. WO 2014/109127.

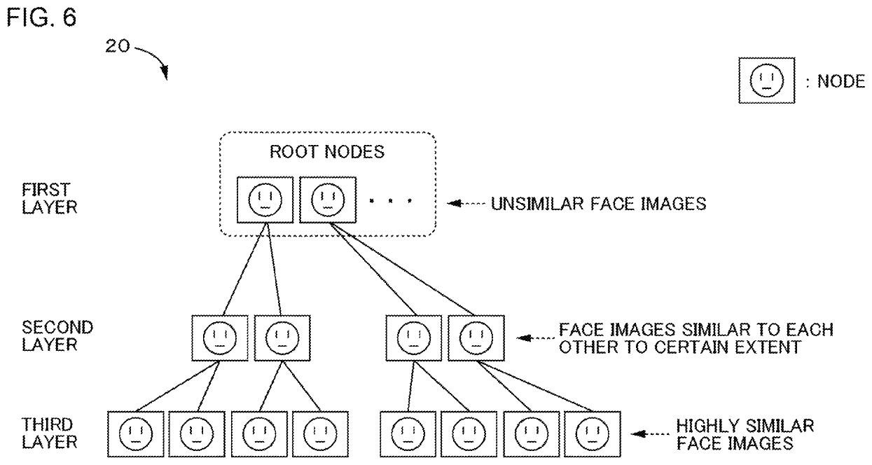

FIG. 6 is a diagram illustrating a similarity tree 20 according to Example 1. The similarity tree 20 is implemented as a tree data structure having a plurality of nodes. In this Example, each node includes a face image. Nodes other than those in the lowermost layer further include pointers to nodes located directly beneath the former nodes. A face image indicated by each root node corresponds to the above-mentioned representative data. The face image indicated by each root node will also be referred to as a representative face image hereinafter.

The similarity tree 20 is formed by three hierarchical layers. A layer in which root nodes are located will be referred to as a first layer, a layer located beneath the first layer will be referred to as a second layer, and a layer located beneath the second layer will be referred to as a third layer hereinafter. Nodes (root nodes) located in the first layer indicate face images less similar to each other. In the second layer, respective nodes located directly beneath the same root node indicate face images similar to each other to a certain extent (their degree of similarity is moderate). In the third layer, nodes located directly beneath the same node in the second layer indicate face images highly similar to each other (their degree of similarity is high). In the third layer, for example, nodes located directly beneath the same node in the second layer indicate face images representing the face of the same person.

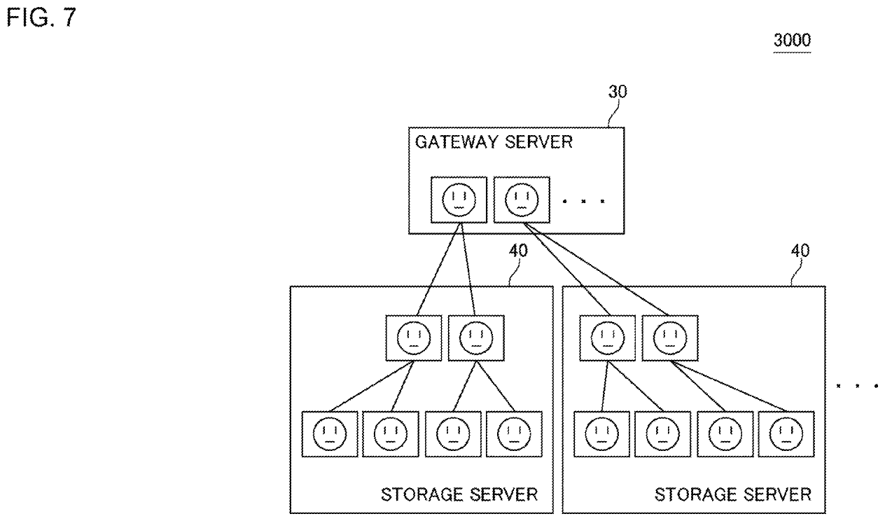

FIG. 7 is a diagram illustrating a distributed storage system 3000 according to Example 1. The distributed storage system 3000 includes a gateway server 30 and a plurality of storage servers 40. The gateway server 30 serves as the information processing apparatus 2000, and the storage servers 40 serve as the storage areas 10.

In the similarity tree 20, the face image indicated by each root node corresponds to representative data. The face image indicated by each root node will also be referred to as a representative face image hereinafter. The management information used by the gateway server 30 indicates thresholds and identifiers for the storage servers 40, in association with representative face images.

The gateway server 30 stores all nodes subordinate to a certain root node in a storage server 40 related to a representative face image indicated by the root node. In other words, all the pieces of data forming a tree structure descending from a root node are stored in the same storage server 40. It should be noted that, a set of tree structures descending from a plurality of root nodes, that is, a plurality of tree structures may be stored in one storage server 40.

The gateway server 30 receives a request for writing indicating target data to be newly added to the similarity tree. A face image acquired as the target data will also be referred to as a target face image hereinafter. The gateway server 30 computes a degree of similarity between a representative face image and a target face image as the evaluation value of the target face image with reference to the representative face image. When the degree of similarity between a representative face image and a target face image is equal to or more than a threshold related to the representative face image, the gateway server 30 adds a node indicating the target face image to the layer located beneath a root node indicating the representative face image. In other words, the node is stored in a storage server 40 related to the representative face image.

The gateway server 30 updates a threshold related to a representative face image, based on the total count or the total data size of nodes subordinate to a root node indicating the representative face image, or the free space of a storage server 40 related to the representative face image. When, for example, the total count of nodes subordinate to a root node is used, a threshold related to a representative face image indicated by the root node is updated to a larger value for a higher total count of nodes subordinate to the root node.

When no representative face image for which the degree of similarity between a target face image and a representative face image is equal to or more than a threshold exists, the gateway server 30 handles the target face image as a new representative face image. Therefore, the gateway server 30 newly generates a root node indicating the new representative face image. The gateway server 30 further generates management information associating a threshold and a storage server 40 with the new representative face image.

Assuming herein that storage servers 40 run short, a new storage server 40 is added to the distributed storage system 3000. In doing so, existing nodes need not be moved. This is because, when a new root node is generated in the future, the added storage server 40 need only be used as a storage area for storing nodes subordinate to the root node.

The gateway server 30 further processes a request for reading which is for reading a face image from the similarity tree. The gateway server 30, for example, reads, from the similarity tree, one or more face images similar to a face image indicated by the request for reading, and transmits a response including the read face image or face images. To do so, the gateway server 30 transmits the face image indicated by the request for reading to a storage server 40. The storage server 40 that receives the face image reads a face image having a high degree of similarity to the received face image (for example, having the degree of similarity equal to or more than a predetermined value) and transmits it to the gateway server 30. With this operation, a face image having a high degree of similarity to the face image indicated by the request for reading is collected from each storage server 40.

The gateway server 30, however, preferably transmits the face image indicated by the request for reading only to a storage server 40 expected to store a face image similar to the indicated face image at a high probability, instead of transmitting the indicated face image to all storage servers 40. Specifically, the gateway server 30 computes a degree of similarity between each representative face image and the face image indicated by the request for reading, and transmits the face image indicated by the request for reading to a storage server 40 related to a representative face image having a degree of similarity equal to or more than a predetermined threshold. The predetermined threshold used herein is set less than any thresholds that have been associated with representative face images so far. Otherwise, some face images cannot be read from the storage servers 40.

According to the above-described Example, in distributing and storing nodes forming a similarity tree in a plurality of storage servers 40, the amount of nodes stored in each storage server 40 can be balanced between the storage servers 40 by a simple method of updating a threshold related to a representative face image.

Example embodiments of the present invention have been described above with reference to the drawings, but they are merely illustrative examples of the present invention, and can adopt various arrangements or configurations other than the foregoing.

Part or all of the above-described example embodiments may be described as in the following supplementary notes, but they are not limited thereto.

1. An information processing apparatus including:

an evaluation unit that acquires target data, and computes, for the acquired target data an evaluation value with reference to each of a plurality of pieces of representative data;

an allocation unit that acquires management information indicating a threshold and a storage area in association with pieces of representative data, determines, for each piece of representative data, whether the evaluation value of the target data with reference to the representative data satisfies a predetermined relationship with the threshold related to the representative data, and stores g the target data in the storage area related to the representative data when the evaluation value of the target data with reference to the representative data satisfies the predetermined relationship with the threshold related to the representative data; and

an update unit that updates the threshold related to the representative data, based on a total size or a total count of pieces of data stored in the storage area related to the representative data, or a free space of the storage area related to the representative data.

2. The information processing apparatus according to 1, wherein

the update unit updates the threshold related to the target data in such a way as to set a lower probability that the threshold related to the representative data and the target data with reference to the representative data satisfy the predetermined relationship, for a larger volume of data stored in the storage area related to the representative data.

3. The information processing apparatus according to 1 or 2, wherein

the allocation unit generates the management information having the target data as new representative data, when it is determined for all pieces of representative data that the evaluation value does not satisfy the predetermined relationship with the threshold related to the representative data.

4. The information processing apparatus according to any one of 1 to 3, wherein

the evaluation value of the target data with reference to the representative data represents a degree of similarity between the representative data and the target data, and the predetermined relationship includes that the evaluation value of the target data with reference to the representative data is equal to or more than the threshold related to the representative data.

5. The information processing apparatus according to 4, wherein

the update unit

sets a larger threshold related to the representative data for a higher total count of pieces of data stored in the storage area related to the representative data,

sets a larger threshold related to the representative data for a larger total size of data stored in the storage area related to the representative data, or

sets a larger threshold related to the representative data for a smaller free space of the storage area related to the representative data.

6. The information processing apparatus according to any one of 1 to 3, wherein

the evaluation value of the target data with reference to the representative data represents a distance between the representative data and the target data, and

the predetermined relationship includes that the evaluation value of the target data with reference to the representative data is equal to or less than the threshold related to the representative data.

7. The information processing apparatus according to 6, wherein

the update unit

sets a smaller threshold related to the representative data for a higher total count of pieces of data stored in the storage area related to the representative data,

sets a smaller threshold related to the representative data for a larger total size of data stored in the storage area related to the representative data, or

sets a smaller threshold related to the representative data for a smaller free space of the storage area related to the representative data.

8. The information processing apparatus according to any one of 1 to 7, wherein

each of the storage areas includes a storage server configuring a storage system,

the evaluation unit receives, from another apparatus a request to store the target data in the storage system, and acquires the target data indicated by the request, and

the allocation unit transmits the target data to the storage server used to store the target data.

9. A control method executed by a computer, including:

an evaluation step of acquiring target data, and computing, for the acquired target data, an evaluation value with reference to each of a plurality of pieces of representative data;

an allocation step of acquiring management information indicating a threshold and a storage area in association with pieces of representative data, determining, for each piece of representative data, whether the evaluation value of the target data with reference to the representative data satisfies a predetermined relationship with the threshold related to the representative data, and storing the target data in the storage area related to the representative data when the evaluation value of the target data with reference to the representative data satisfies the predetermined relationship with the threshold related to the representative data; and

an update step of updating the threshold related to the representative data, based on a total size or a total count of pieces of data stored in the storage area related to the representative data, or a free space of the storage area related to the representative data.

10. The control method according to 9, wherein

in the update step, the threshold related to the target data is updated in such a way as to set a lower probability that the threshold related to the representative data and the target data with reference to the representative data satisfy the predetermined relationship, for a larger volume of data stored in the storage area related to the representative data.

11. The control method according to 9 or 10, wherein

in the allocation step, the management information having the target data as new representative data is generated when it is determined for all pieces of representative data that the evaluation value does not satisfy the predetermined relationship with the threshold related to the representative data.

12. The control method according to any one of 9 to 11, wherein

the evaluation value of the target data with reference to the representative data represents a degree of similarity between the representative data and the target data, and

the predetermined relationship includes that the evaluation value of the target data with reference to the representative data is equal to or more than the threshold related to the representative data.

13. The control method according to 12, wherein

in the update step,

a larger threshold related to the representative data is set for a higher total count of pieces of data stored in the storage area related to the representative data,

a larger threshold related to the representative data is set for a larger total size of data stored in the storage area related to the representative data, or

a larger threshold related to the representative data is set for a smaller free space of the storage area related to the representative data.

14. The control method according to any one of 9 to 11, wherein

the evaluation value of the target data with reference to the representative data represents a distance between the representative data and the target data, and

the predetermined relationship includes that the evaluation value of the target data with reference to the representative data is equal to or less than the threshold related to the representative data.

15. The control method according to 14, wherein

in the update step,

a smaller threshold related to the representative data is set for a higher total count of pieces of data stored in the storage area related to the representative data,

a smaller threshold related to the representative data is set for a larger total size of data stored in the storage area related to the representative data, or

a smaller threshold related to the representative data is set for a smaller free space of the storage area related to the representative data.

16. The control method according to any one of 9 to 15, wherein

each of the storage areas includes a storage server configuring a storage system,

in the evaluation step, a request to store the target data in the storage system is received from another apparatus, and the target data indicated by the request is acquired, and

in the allocation step, the target data is transmitted to the storage server used to store the target data.

17. A program for causing a computer to execute each of steps of the control method according to any one of 9 to 16.

This application is based upon and claims the benefit of priority from Japanese patent application No. 2017-247545, filed on Dec. 25, 2017, the disclosure of which is incorporated herein in its entirety by reference.

1. An information processing apparatus comprising:
evaluation unit that acquires target data, and computes, for the acquired target data, an evaluation value with reference to each of a plurality of pieces of representative data;
allocation unit that acquires management information indicating a threshold and a storage area in association with pieces of representative data, determines, for each piece of representative data, whether the evaluation value of the target data with reference to the representative data satisfies a predetermined relationship with the threshold related to the representative data, and stores the target data in the storage area related to the representative data when the evaluation value of the target data with reference to the representative data satisfies the predetermined relationship with the threshold related to the representative data; and
update unit that updates the threshold related to the representative data, based on a total size of data stored in the storage area related to the representative data, a total count of pieces of data stored in the storage area related to the representative data, or a free space of the storage area related to the representative data.

2. The information processing apparatus according to claim 1, wherein
the update unit updates the threshold related to the representative data in such a way as to set a lower probability that the threshold related to the representative data and the evaluation value of the target data with reference to the representative data satisfy the predetermined relationship, for a larger volume of data stored in the storage area related to the representative data.

3. The information processing apparatus according to claim 1, wherein
the allocation unit generates the management information having the target data as new representative data, when it is determined for all pieces of representative data that the evaluation value does not satisfy the predetermined relationship with the threshold related to the representative data.

4. The information processing apparatus according to claim 1, wherein
the evaluation value of the target data with reference to the representative data represents a degree of similarity between the representative data and the target data, and
the predetermined relationship includes that the evaluation value of the target data with reference to the representative data is equal to or more than the threshold related to the representative data.

5. The information processing apparatus according to claim 4, wherein
the update unit
sets a larger threshold related to the representative data for a higher total count of pieces of data stored in the storage area related to the representative data,
sets a larger threshold related to the representative data for a larger total size of data stored in the storage area related to the representative data, or
sets a larger threshold related to the representative data for a smaller free space of the storage area related to the representative data.

6. The information processing apparatus according to claim 1, wherein
the evaluation value of the target data with reference to the representative data represents a distance between the representative data and the target data, and
the predetermined relationship includes that the evaluation value of the target data with reference to the representative data is equal to or less than the threshold related to the representative data.

7. The information processing apparatus according to claim 6, wherein
the update unit
sets a smaller threshold related to the representative data for a higher total count of pieces of data stored in the storage area related to the representative data,
sets a smaller threshold related to the representative data for a larger total size of data stored in the storage area related to the representative data, or
sets a smaller threshold related to the representative data for a smaller free space of the storage area related to the representative data.

8. The information processing apparatus according to claim 1, wherein
each of the storage areas includes a storage server configuring a storage system,
the evaluation unit receives, from another apparatus, a request to store the target data in the storage system, and acquires the target data indicated by the request, and
the allocation unit transmits the target data to the storage server used to store the target data.

9. A control method executed by a computer, comprising:
an evaluation step of acquiring target data, and computing, for the acquired target data, an evaluation value with reference to each of a plurality of pieces of representative data;
an allocation step of acquiring management information indicating a threshold and a storage area in association with pieces of representative data, determining, for each piece of representative data, whether the evaluation value of the target data with reference to the representative data satisfies a predetermined relationship with the threshold related to the representative data, and storing the target data in the storage area related to the representative data when the evaluation value of the target data with reference to the representative data satisfies the predetermined relationship with the threshold related to the representative data; and
an update step of updating the threshold related to the representative data, based on a total size of data stored in the storage area related to the representative data, a total count of pieces of data stored in the storage area related to the representative data, or a free space of the storage area related to the representative data.

10. The control method according to claim 9, wherein
in the update step, the threshold related to the representative data is updated in such a way as to set a lower probability that the threshold related to the representative data and the evaluation value of the target data with reference to the representative data satisfy the predetermined relationship, for a larger volume of data stored in the storage area related to the representative data.

11. The control method according to claim 9, wherein
in the allocation step, the management information having the target data as new representative data is generated when it is determined for all pieces of representative data that the evaluation value does not satisfy the predetermined relationship with the threshold related to the representative data.

12. The control method according to claim 9, wherein
the evaluation value of the target data with reference to the representative data represents a degree of similarity between the representative data and the target data, and
the predetermined relationship includes that the evaluation value of the target data with reference to the representative data is equal to or more than the threshold related to the representative data.

13. The control method according to claim 12, wherein
in the update step,
a larger threshold related to the representative data is set for a higher total count of pieces of data stored in the storage area related to the representative data,
a larger threshold related to the representative data is set for a larger total size of data stored in the storage area related to the representative data, or
a larger threshold related to the representative data is set for a smaller free space of the storage area related to the representative data.

14. The control method according to claim 9, wherein
the evaluation value of the target data with reference to the representative data represents a distance between the representative data and the target data, and
the predetermined relationship includes that the evaluation value of the target data with reference to the representative data is equal to or less than the threshold related to the representative data.

15. The control method according to claim 14, wherein
in the update step,
a smaller threshold related to the representative data is set for a higher total count of pieces of data stored in the storage area related to the representative data,
a smaller threshold related to the representative data is set for a larger total size of data stored in the storage area related to the representative data, or
a smaller threshold related to the representative data is set for a smaller free space of the storage area related to the representative data.

16. The control method according to claim 9, wherein
each of the storage areas includes a storage server configuring a storage system,
in the evaluation step, a request to store the target data in the storage system is received from another apparatus, and the target data indicated by the request is acquired, and
in the allocation step, the target data is transmitted to the storage server used to store the target data.

17. A non-transitory storage medium storing a program for causing a computer to execute each of steps of the control method according to claim 9.
